(19) United States
(12) Patent Application Publication
(10) Pub. No.: US 2018/0168921 A1
(43) Pub. Date: Jun. 21, 2018

(54) Method and Apparatus for Targeted Micro Vibration

(71) Applicant: Simon Ourian, Beverly Hills, CA (US)

(72) Inventor: Simon Ourian, Beverly Hills, CA (US)

(21) Appl. No.: 15/385,572

(22) Filed: Dec. 20, 2016

(51) Int. Cl. A61H 23/00

(52) U.S. Cl. CPC A61H 23/00; A61H 2201/0153

(57) ABSTRACT

In accordance with one embodiment, a method and apparatus for micro vibration, generally comprising a handheld device with a terminus having a micro vibration bar, is provided for use in combination with methods of use designed to disrupt the brain's perception of painful stimuli originating from a pain source nearby or imminently adjacent to the apparatus, thereby alleviating in part or in total the subject's perceived pain.

### CROSS-REFERENCE TO RELATED APPLICATIONS

None.

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### TECHNICAL FIELD

The present invention relates to a micro vibration apparatuses. More specifically, the present invention relates to a micro vibration device for reducing pain perception, and to a method for using the same.

### BACKGROUND

The cognitive processing of pain signals and the subsequent awareness of pain, or “pain perception,” is a complex phenomenon that is not fully understood. In many instances, it is advantageous to reduce or prevent a person, animal, or other sentient being's perception of pain.

Generally, pain perception begins when a nerve detects an injury or an insult to the tissue integrity of an organism. The nerve then sends a signal to the organism's central nervous system, where the signal is received, interpreted, and then perceived as painful.

Many approaches exist to prevent or mitigate the perception of pain. Targets of pain mitigation therapy might include nerve's activation, the signal's transmission, or the central nervous system's interpretation of the signal. Moreover, a wide array of treatment options exist that aim at these and other elements of pain perception. Such treatment options may utilize, for example, pharmaceutical substances, natural remedies, meditation, or tissue massage. Unfortunately, all of these treatment options possess deficiencies or drawbacks. For example, pharmaceuticals can lead to dependency, natural remedies can be ineffective, meditation can be interrupted, and tissue massage can exacerbate the problem. For these reasons and others, there exists a need for additional treatment options.

One treatment approach aimed at altering, reducing, or eliminating pain perception is the targeted use of vibration. Generally, this technique utilizes a source of reverberation to send vibration signals to the subject's central nervous system that take priority of perception over simultaneous pain signals, thereby masking, altering, or otherwise diminishing the central nervous system's perception of the pain signals. Preferably, the location or source of the vibration is in contact with, immediately adjacent to, or nearby the location of the pain source.

Many types of vibration have been identified. The term “micro vibration” can generally be associated with vibrations having ultra-high frequency and ultra-low altitude. This term can also be associated with vibrations of lower perceived intensity or as affecting a small surface area. Those of skill in the art will appreciate that some, all, or none of these aspects may apply to the present invention's vibratory function.

Those of skill in the art will also appreciate that there are many ways to utilize vibration to mitigate pain perception, and that different techniques are likely to achieve different results. These techniques could differ with respect to, by way of illustration and not of limitation, the type of vibration signals, the orientation of the vibration device relative to the pain source, the surface area vibrated, and the distance between the pain source and the vibration source. While various techniques and apparatuses are presently known that use vibration to alter pain perception according to some or all of these techniques, they unfortunately fail to adequately address the problem of pain perception.

One example of this treatment approach is described in the journal article “Syringe micro vibrator (SMV) a new device being introduced in dentistry to alleviate pain and anxiety of intraoral injections, and a comparative study with a similar device,” written by Amir Hashem and Shahidi Bonjar, published in Annals of Surgical Innovation and Research in 2011¹, and incorporated by reference in its entirety herein. In this publication, the authors describe a device that mounts to a syringe, vibrates the syringe and its needle, thereby using vibration to disrupt the brain's pain gate. While the authors report that this combination does reduce a subject's pain perception, one drawback of the arrangement is that the location of the vibration and the location of the pain, relative to the subject's exposed tissue, are by necessity the same, because the source of the vibration is attached to the source of the pain. Another drawback is that the surface area of the subject's tissue affected by the vibration is limited to the size of the needle. ¹Shahidi Bonjar, A. H. (2011). Syringe micro vibrator (SMV) a new device being introduced in dentistry to alleviate pain and anxiety of intraoral injections, and a comparative study with a similar device. Annals of Surgical Innovation and Research, 5, 1. http://doi.org/10.1186/1750-1164-5-1

Another unsatisfactory attempt at solving this problem is the apparatus described in U.S. Pat. No. 9,439,829 B2. This publication generally teaches an apparatus that provides for a circular ring of vibration that encircles an injection needle. While this apparatus does provide for a larger, ring-shaped vibration area as well as a space between the injection source and the vibration source, it nevertheless limits the user to a circular vibration shape and does not allow the user to vary the distance between the injection and its associated pain and the vibration.

Another such apparatus is described in U.S. Patent Application Publication No. 2010/0179455 A1. This application generally teaches a hand-held device, attached to a generator and a console, that delivers electromagnetic energy to a subject's tissues in an effort to disrupt pain signal transmission. While this application does generally teach an apparatus disconnected from a syringe, and therefore one capable of administration at any distance from the source of the subject's pain, it is limited to a square shaped tip and the technique of electromagnetic, rather than mechanic, tissue vibration.

Another such apparatus is described in U.S. Patent Application Publication No. 2004/0015188 A1. This application generally discloses a device that uses Trans Epithelial Nerve Stimulation in combination with an injection apparatus. While this application generally teaches a larger target surface area, it fails to utilize micro vibrations and also does not allow the user to adjust the difference between the disruption activity and the injection source.

Still, none of these in existence comprise beneficial characteristics descried in the following disclosure. Thus, there is a need for a method and apparatus which effectively utilizes the targeted application of micro vibrations to overcome the deficiencies in the prior art.

### SUMMARY

The present invention advances the art and overcomes the aforementioned deficiencies by providing for a handheld micro vibration apparatus that permits a user to apply micro vibrations as near or as far from a source of pain as the user may wish. In one embodiment, the apparatus may comprise a cylindrical base with two ends, one end of which is generally conical and provides for an on/off switch element, the other end of which provides for a T-shaped terminus having a micro vibration bar. The present invention also provides for corresponding methods of use, in which the user grasps the base element, activates the apparatus such as by switching it into the “on” position, and target the micro vibrations by placing a portion of the apparatus on a subject's exposed skin at a specific location chosen to most effectively mitigate the sensation of pain.

The present invention further provides a method of applying micro vibrations to a subject's exposed skin at a location chosen in relation to a pain source, wherein the user may utilize the apparatus to apply micro vibrations immediately adjacent to or in contact with the pain source, such as for example a location immediately adjacent to or in contact with an injection source.

The present invention further provides a method of applying targeted micro vibrations to a subject's exposed skin tissue at a targeted location strategically chosen to most effectively mitigate any sensation of pain.

### DESCRIPTION OF THE DRAWINGS

Figures

FIG. 1 illustrates a method of applying micro vibrations to a subject's exposed skin tissue imminently adjacent to or in contact with a pain source in accordance with one embodiment of the invention;

FIG. 2 illustrates a method of applying micro vibrations to a subject's exposed tissue nearby a pain source in accordance with one embodiment of the invention;

FIG. 3 is a side-perspective view of an exemplary apparatus from FIG. 1 in accordance with one embodiment of the invention;

FIG. 4 is a top-elevational view of the exemplary apparatus from FIG. 1 in accordance with one embodiment of the invention;

FIG. 5 is a first-end planar view of the exemplary apparatus from FIG. 1 in accordance with one embodiment of the invention; and

FIG. 6 is a second-end planar view of the exemplary apparatus from FIG. 1 in accordance with one embodiment of the invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non- exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

The term “immediately adjacent” and the like should be broadly understood and refer to the positions of two or more objects relative to each other wherein two or more objects are very close to each other but not touching. One illustrative and non-limiting range could be that the two objects are less than one-sixteenth ( 1/16^{th}) of an inch apart.

The term “nearby” and the like should be broadly understood and refer to the positions of two or more objects relative to each other. One illustrative and non-limiting range could be that the two objects are between one-sixteenth ( 1/16^{th}) of an inch and three (3) inches apart.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

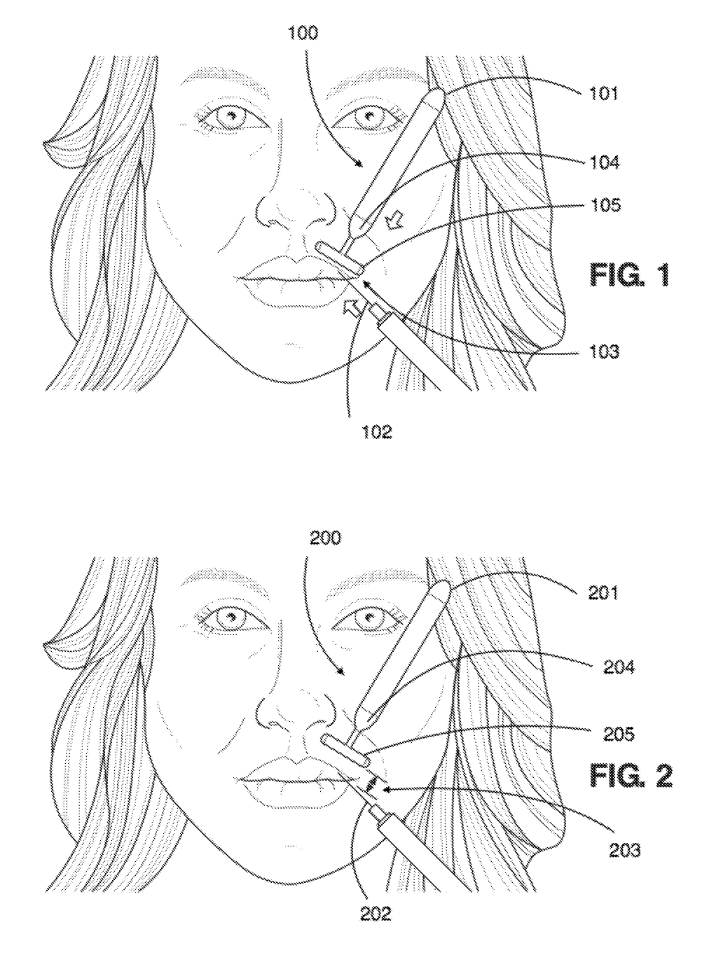

Exemplary actions that embody aspects of the invention are shown in FIGS. 1 and 2. It should be understood that the invention is not limited to these actions. Rather the actions have been selected to demonstrate to those skilled in the art the variety of actions contemplated by the invention, so that they can better understand the invention and be able to create additional actions. It should also be understood that the drawings are not exact replications of an action, but are only meant to illustrate the relative positions of the apparatus and pain source so that the action can be better understood.

FIG. 1 illustrates a method of applying targeted micro vibrations to a subject's exposed skin tissue imminently adjacent to or in contact with a pain source according to one embodiment of the present invention. In this illustrative embodiment, the user first activates an oscillator within the apparatus' by moving an on/off switch 101 to the “on” position, and inserts a needle 102 into a subject's skin 103, then presses the apparatus' terminus 104 and its associated micro vibration bar 105 onto a selected location on the subject's skin 103 immediately adjacent to the needle 102, thereby temporarily desensitizing the region. In another embodiment, the user may switch the apparatus' on/off switch 101 to the “on” position, press the apparatus' terminus 104 and its associated micro vibration bar 105 onto a selected location on the subject's skin 103 thus temporarily desensitizing that region, then inserting the needle 102 into the subject's skin 103 immediately adjacent to the terminus 104.

In another embodiment, the user may switch the apparatus' on/off switch 101 to the “on” position and simultaneously press the apparatus' terminus 104 and its associated micro vibration bar 105 onto a selected region of the subject's skin 103 while also inserting a needle 102 into the skin 103 at a location immediately adjacent to the apparatus' terminus 104 and its associated micro vibration bar 105. Those of skill in the art will note that the above-described method could also be performed on any tissue capable of transmitting pain signals originating at the skin.

FIG. 2 illustrates a method of applying micro vibrations to a subject's exposed skin tissue nearby a pain source according to the present invention. In this illustrative embodiment, the user first switches the apparatus' on/off switch 201 to the “on” position, then inserts a needle 202 into a subject's skin 203, then presses the terminus 204 and its associated micro vibration bar 205 onto the subject's skin 203 nearby the needle 202, thereby applying micro vibrations to that selected area.

In another embodiment the user may switch the apparatus' on/off switch 201 to the “on” position, presses the terminus 204 and its associated micro vibration bar 205 onto a selected spot on the subject's skin 203, then inserts the needle 202 into the skin 203 in a location nearby the terminus 204.

In yet another embodiment the user may switch the apparatus' on/off switch 201 to the “on” position and simultaneously presses the terminus 204 and its associated micro vibration bar 205 onto a selected spot of the subject's skin 203 while also inserting a needle 202 into the subject's skin 203 at a location nearby the location of the terminus 204 and its associated micro vibration bar 205. Those of skill in the art will note that the above-described method could also be performed on a subject's gums or other tissues capable of propagating at least one pain signal.

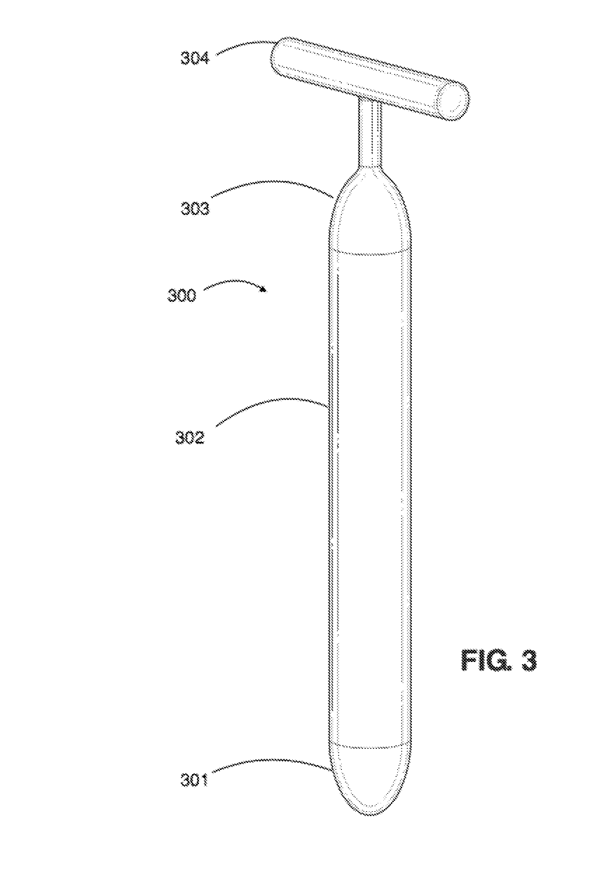

FIG. 3 illustrates a side-perspective view of the apparatus according to the present invention. In the embodiment shown, the apparatus 300 contains a conical, rotatable on/off end element 301 that, when rotated to either the “on” or the “off” position, causes the apparatus 300 to turn on or turn off, respectively. FIG. 3 also illustrates that the apparatus 300 possesses a base element 302, attached to a terminus 303 that contains a micro vibration bar 304. When the on/off switch is in the “on” position, the terminus 303, and the micro vibration bar 304, may vibrate when the apparatus 300 is on and may also transfer micro vibrations to a subject's skin when the skin and the apparatus 300 come into physical contact.

In some embodiments, by way of illustration and not of limitation, apparatus 300 may contain an end element 301 with a flat, rather than conical, end surface. Alternatively, end element 301 may contain a button that performs the on/off function. Alternatively, end element 301 may provide for a touch-operated on/off element. Alternatively, end element 301 may contain an orientation-activated on/off element wherein the apparatus 300 is switched on when the apparatus 300 is rotated from a vertical to a horizontal orientation. Alternatively, end member 301 may contain a slide-operated on/off element.

In some embodiments, by way of illustration and not of limitation, apparatus 300 may contain a curved base member 302. Alternatively, base member 302 may contain a touch sensor. In another embodiment, the base member 302 may provide for one or more traction pads that may stabilize or provide friction to a users' fingers. Moreover, the base member 302 may provide for one or more illumination elements to provided targeted light onto the subject's skin. Furthermore, the base member 302 may provide for one or more loop or hooked elements wherein users may insert one or more fingers. In another embodiment, it is envisioned that the base member 302 may be composed from one or more substances or elements, or combinations of elements for minimizing weight, such as, by way of illustration and not of limitation, carbon fiber, plastic or other lightweight substances; aluminum or other lightweight metals; titanium or other resilient metals; gold or other expensive or valuable metals, or any other substance suitable to the function of base member 302. The base member 302 may further be embellished with diamonds or other ornamentation for personalized use. Furthermore, the base member 302 may be ring, oval, square, or flat-planar shaped, or other suitable shape. Alternatively, base member 302 may provide for one or more indentations wherein a user may rest one or more fingers in order to, by way of illustration and not of limitation, better control the pressure or location of the micro vibrations produced by apparatus 300.

In some embodiments, base member 302 may provide for one or more power source or power repository elements, including rechargeable or non-rechargeable batteries, wired power, or solar batteries or solar power cells. Alternatively, base member 302 may provide for a motion-based recharging element of said power source or power repository element. In yet another embodiments, said power source or power repository is capable of transferring between 0.1V and 24V to one or more vibration-producing motors.

In some embodiments, the base member 302 may comprise one or more motors capable of generating vibrations and micro vibrations. By way of illustration and not of limitation, said motor could incorporate an eccentric rotating mass vibration motor and utilize a small unbalanced mass and direct current. Alternatively, said motor could incorporate a linear resonant actuator, potentially containing a small internal mass attached to a spring. Alternatively, said motor could operate according to a different mechanism. In some embodiments, said motor may be a cylindrical or “coin” style motor, a disc-shaped or “pancake” or “flat” motor, or other suitable motor size and shape. Preferably, said motor is capable of generating between 1 and 283 Hz. In some embodiments, the apparatus 300 may provide for vibration transfer from a motor located within base member 302 to the micro vibration bar 304. In another embodiments, said motor is capable of pulsed or uneven vibration output.

In some embodiments, by way of illustration and not of limitation, apparatus 300 may contain a T-shaped terminus 303. Alternatively, terminus 303 may be configured, constructed, or designed as a triangle, circle, oval, cylinder, or other commonly known shape. Alternatively, terminus 303 may be composed of the same or different substances as base member 302. Alternatively, terminus 303 may be of one piece with base element 302. Alternatively, terminus 303 may contain an illumination element. Alternatively, terminus 303 may be curved. Alternatively, terminus 303 may detach and reattach to base member 302, thereby providing for a kit or assembly of potential attachments.

In some embodiments, micro vibration bar 304 may be curved, circular, or another shape. Alternatively, micro vibration bar 304 may provide for one or more interchangeable attachments that detachably connect with terminus 303. Moreover, micro vibration bar 304 may also include one or more illumination elements. In one embodiment, micro vibration bar 304 may be configured in a shape inspired by nature, such as a leaf or a butterfly. Alternatively, one or more surfaces of micro vibration bar 304 may contain texture, scoring, raised or varied structure elements that allow the user to provide more precise contact surfaces between micro vibration bar 304 and the intended target surface. Alternatively, the micro vibration bar 304 may be composed or constructed from the same or similar materials as base member 302. Alternatively, micro vibration bar 304 and terminus 303 may be of one piece. Alternatively, micro vibration bar 304, terminus 303, and base element 302 may be of one piece.

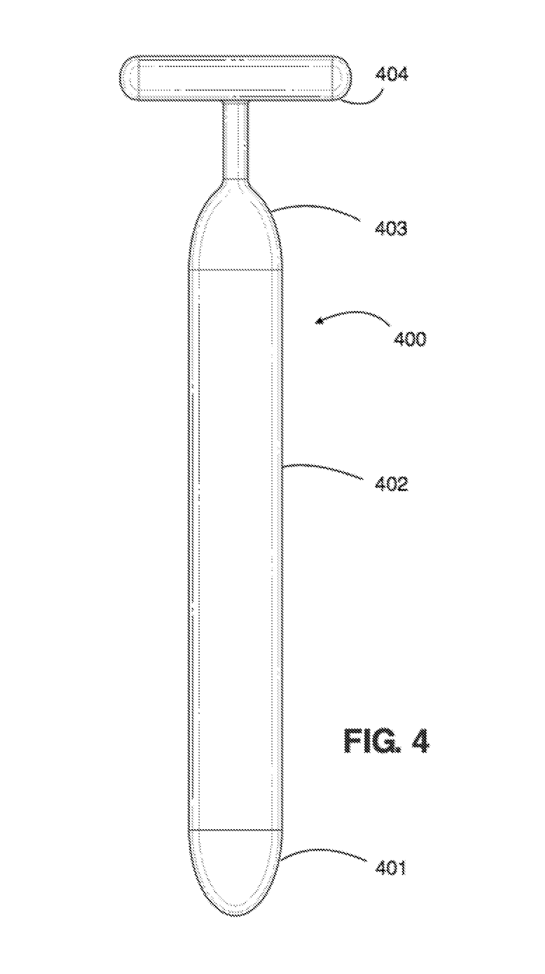

FIG. 4 is an illustration of a top-elevational view of the apparatus according to the present invention. In the depicted embodiment, an apparatus 400, a conical and rotatable on/off switch end element 401, a base member 402, a terminus 403, and a micro vibration bar 404 are provided. FIG. 4 further discloses that the micro vibration bar 404 which is illustrated as cylindrical in this embodiment. FIG. 4 further discloses that the micro vibration bar 404 and the base member 402 is illustrated as co-planar in this embodiment of the present disclosure. FIG. 4 further discloses that the micro vibration bar 404 and the base element 403 are orthogonally oriented.

In some embodiments, by way of illustration and not of limitation, apparatus 400 may contain an end element 401 with a flat, rather than conical, end surface. Alternatively, end member 401 may contain a button that performs the on/off function. Alternatively, end member 401 may provide for a touch-operated on/off element. Alternatively, end member 401 may contain an orientation-activated on/off element wherein the apparatus 400 is switched on when the apparatus 400 is rotated from a vertical to a horizontal orientation. Alternatively, end member 401 may contain a slide-operated on/off element.

In some embodiments, by way of illustration and not of limitation, apparatus 400 may contain a curved base member 402. Moreover, base member 402 may contain a touch sensor. Alternatively, base member 402 may provide for one or more traction pads that may stabilize or provide friction to a users' fingers. furthermore, base member 402 may provide for one or more illumination elements. In one embodiment, base member 402 may provide for one or more loop or hooked elements wherein users may insert one or more fingers. Alternatively, base member 402 may be composed from one or more substances or elements, or combinations of elements, such as by way of illustration and not of limitation carbon fiber, plastic or other lightweight substances; aluminum or other lightweight metals; titanium or other resilient metals; gold or other expensive or valuable metals, or any other substance suitable to the function of base member 402. In yet another embodiment, base member 402 may be embellished with diamonds or other ornamentation. Alternatively, base member 402 may be ring, oval, square, or flat-planar shaped, or other suitable shape. Alternatively, base member 402 may provide for one or more indentations wherein a user may rest one or more fingers in order to, by way of illustration and not of limitation, better control the pressure or location of the micro vibrations produced by apparatus 400.

In some embodiments, base member 402 may provide for one or more power source or power repository elements, including rechargeable or non-rechargeable batteries, wired power, or solar batteries or solar power cells. Alternatively, base member 402 may provide for a motion-based recharging element of said power source or power repository element. In preferred embodiments, said power source or power repository is capable of transferring between 0.1V and 24V to one or more vibration-producing motors.

In some embodiments, base member 402 may contain one or more motors capable of generating vibrations and micro vibrations. By way of illustration and not of limitation, said motor could incorporate an eccentric rotating mass vibration motor and utilize a small unbalanced mass and direct current. Alternatively, said motor could incorporate a linear resonant actuator, potentially containing a small internal mass attached to a spring. Alternatively, said motor could operate according to a different mechanism. In some embodiments, said motor may be a cylindrical or “coin” style motor, a disc-shaped or “pancake” or “flat” motor, or other suitable motor size and shape. Preferably, said motor is capable of generating between 1 and 283 Hz. In preferred embodiments, apparatus 400 provides for vibration transfer from a motor located within base member 402 to the micro vibration bar 404. In preferred embodiments, said motor is capable of pulsed or uneven vibration output.

In some embodiments, by way of illustration and not of limitation, apparatus 400 may contain a T-shaped terminus 403. Alternatively, terminus 403 may be configured, constructed, or designed as a triangle, circle, oval, cylinder, or other commonly known shape. Alternatively, terminus 403 may be composed of the same or different substances as base element 402. Alternatively, terminus 403 may be of one piece with base element 402. Alternatively, terminus 403 may contain an illumination element. Alternatively, terminus 403 may be curved. Alternatively, terminus 403 may detach and reattach to base member 402, thereby providing for a kit or assembly of potential attachments.

In some embodiments, micro vibration bar 404 may be curved, circular, or another shape. Alternatively, micro vibration bar 404 may provide for one or more interchangeable attachments that detachably connect with terminus 403. Alternatively, micro vibration bar 404 may also include one or more illumination elements. Alternatively, micro vibration bar 404 may be configured in a shape inspired by nature, such as a leaf or a butterfly. Alternatively, one or more surfaces of micro vibration bar 404 may contain texture, scoring, raised or varied structure elements that allow the user to provide more precise contact surfaces between micro vibration bar 404 and the intended target surface. Alternatively, the micro vibration bar 404 may be composed or constructed from the same or similar materials as base element 402. Alternatively, micro vibration bar 404 and terminus 403 may be of one piece. Alternatively, micro vibration bar 404, terminus 403, and base member 402 may be of one piece.

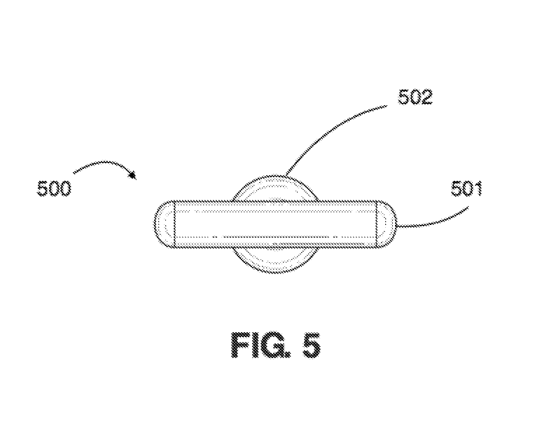

FIG. 5 is an illustration of a second-end planar view of the apparatus 500 according to the present invention. In the embodiment depicted, for illustration only, the micro vibration bar 501 may be observed in relative proportion to the apparatus' base member 502.

In some embodiments, by way of illustration and not of limitation, base element 502 may be shaped as a square, rectangle, or other shape conducive to the successful practice of the present invention. Alternatively, micro vibration bar 501 may be flat or possess sharper-edged corners. Various embodiments may incorporate different relative dimensions of vibration bar 501 and base member 502.

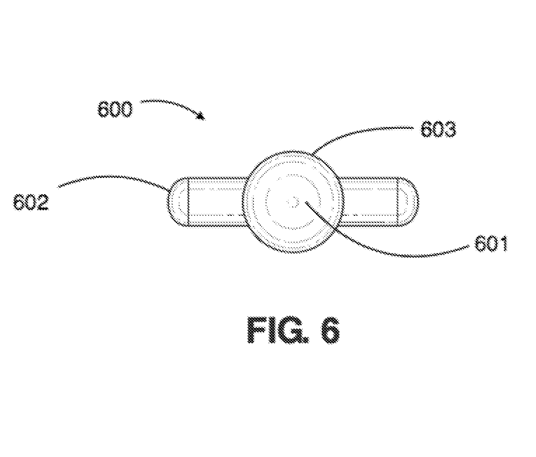

FIG. 6 is an illustration of a first-end planar view of the apparatus 600 according to the present invention. In the embodiment depicted, a conical and rotatable on/off switch end member 601 may be observed in relative proportion to the micro vibration bar 602 and the base member 603.

In some embodiments, by way of illustration and not of limitation, end member 601 may have a different shape, such by way of illustration and not of limitation, having a flat terminal edge. Alternatively, end member 601 may incorporate a sliding switch or touch-operated on/off element. Alternatively, end member 601 may be larger or smaller in diameter than base member 603. Alternatively, end member 601 may contain one or more illumination elements.

Although the invention has been described with reference to specific embodiments, it will be understood by those skilled in the art that various changes may be made without departing from the scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While a particular form of the invention has been illustrated and described, it will be apparent that various modifications can be made without departing from the spirit and scope of the invention. For example, an apparatus and associated method for micro vibration is illustrated in various forms that differ in, among other factors, the distance and orientation of the apparatus and the source of subject's pain in relationship to each other, in some embodiments even though the inventor contemplates the possibility that the apparatus may be used in many different orientations and distances from the source of the subject's pain. Accordingly, it is not intended that the invention be limited, except as by the appended claims.

The teachings provided herein can be applied to other systems, not necessarily the apparatus described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the method and apparatus for micro vibration with which that terminology is associated. In general, the terms used in the following claims should not be constructed to limit the method and apparatus for micro vibration to the specific embodiments disclosed in the specification, unless the above description section explicitly define such terms. Accordingly, the actual scope encompasses not only the disclosed embodiments, but also all equivalent ways of practicing or implementing the disclosed method and apparatus. The above description of embodiments of the method and apparatus for micro vibration is not intended to be exhaustive or limited to the precise form disclosed above or to a particular field of usage. While specific embodiments of, and examples for, the method and apparatus are described above for illustrative purposes, various equivalent modifications are possible which those skilled in the relevant art will recognize.

While certain aspects of the method and apparatus for micro vibration are presented below in particular claim forms, the inventor contemplates the various aspects of the method and apparatus in any number of claim forms. Accordingly, the inventor reserves the right to add additional claims after filing the application to pursue such additional claim forms for other aspects of the method and apparatus for micro vibration.

What is claimed is:

1. An apparatus for micro vibration, comprising:
a cylindrical base element having a first end and a second end, said first end having a conical element, said second end having a terminus; and said terminus having at least one micro vibration bar.

2. The apparatus of claim 1, wherein the terminus and the micro vibration bar are orthogonally positioned relative to each other.

3. The apparatus of claim 1, wherein the conical element is rotatably attached to the base element.

4. The apparatus of claim 1, wherein the terminus is T-shaped.

5. The apparatus of claim 3, the conical element having an on setting and an off setting.

6. A method for micro vibration, comprising:
providing a handheld apparatus for use in administering micro vibrations, said apparatus having a cylindrical base element, said base element having a conical first end and a second end, said conical first end rotatably attached to said base element, said conical first end containing an on/off element, said second end having a terminus containing a micro vibration bar; providing a subject having at least one section of exposed tissue, said section of tissue containing at least one nerve capable of transmitting at least one pain signal to a brain; providing a pain source capable of causing at least one pain signal to travel from a nerve to a brain; causing said pain source to cause a nerve in said section of exposed tissue to transmit at least one pain signal to a brain;
turning said conical first end to the “on” position; and placing said micro vibration bar on said section of exposed tissue in a location immediately adjacent to or in contact with the pain source.

7. The method of claim 6, wherein the micro vibration bar is placed between one-sixteenth of an inch and three inches away from the pain source.

8. The method of claim 6, wherein the terminus is T-shaped.
